(19) United States
(12) Patent Application Publication
(10) Pub. No.: US 2015/0235198 A1
(43) Pub. Date: Aug. 20, 2015

(54) Method for Configuring a Mobile Communication Device, Device thus Configured, Method, System for Authorizing Transactions on an Online Account, and Method for Obtaining, by an Initiating Party, a Permission from an Authorizing Party to a Service Provider for Performing a Transaction on an Account of the User

(71) Applicant: Greenchili B.V., Schiphol (NL)

(72) Inventors: Michiel Laurens Jakob Liezenberg, Aerdenhout (NL); Ruben Van Eijnatten, Den Haag (NL)

(21) Appl. No.: 14/429,627

(22) PCT Filed: Sep. 19, 2013
(86) PCT No.: PCT/EP2013/069470

§ 371 Date: Mar. 19, 2015

Related U.S. Application Data
(60) Provisional application No. 61/702,808, filed on Sep. 19, 2012.

(51) Int. Cl. G06Q 20/32; H04W 4/00; H04W 12/06; G06Q 20/40

(52) U.S. Cl. CPC G06Q 20/322; G06Q 20/40; H04W 4/001; H04W 4/003; H04W 12/06

(57) ABSTRACT

The present invention relates to a method for configuring a mobile communication device, comprising the steps of installing an application from an app store on the mobile communication device; activating or personalising the application on the mobile communication device; providing a list of possible service providers by the application; selecting a service provider from a list of possible service providers in the application; generating a unique code for a selected service provider by a platform server, and communicating said unique code to the mobile communication device; entering the unique code on a website of said service provider; sending the entered unique code by the service provider to the platform server for verification; upon verification of the unique code, generating a unique identification code and sending it to the service provider, and to the application.

This invention is directed to an authorization method and system and more particularly an authorization method and system that utilizes an application for a mobile telephone.

Various (payment) authorization methods and systems are well known in the art and used in relation to specifically checks, or credit cards, or debit cards, or wallets, or money transfers, or the like, also in relation to the mobile phone. When authorization is required in the context of an in-store, on-site, online or mobile point of sale or bill payment or person to person payment, the transaction can be time consuming and may require a user to carry and maintain multiple (payment) authorization instruments for multiple accounts with different providers, memorizing different authorization methods and codes. Also, for online authorizations a user is required to input both personal and financial information, which is time consuming and risk prone. All of these methods are complicated if the user wishes to include additional payment instruments, use marketing or loyalty instruments or use alternative currencies in the same transaction, e.g. use a gift card, redeem a coupon, use or receive reward points or punches, use virtual currencies. In addition, being able to combine such payment and loyalty instruments in transactions in all the said contexts could create new possibilities that are simply not feasible today for different reasons. E.g. pay with payment account+giftcard+coupon for a single transaction, issue instant rewards on early bill payment, coupon redemption and rewards issuing at on-site payment or delivery of goods, forwarding or sharing coupons.

Therefore a need exists for an authorization method and system that enables end-to-end secured authorization of transactions on online accounts, with a simple and consistent user experience across all transaction contexts. The transactions may comprise all kinds of transactions that require authorization, such as performing payments and providing credentials. The method and system includes a simple application used with a smartphone that is capable of issuing tickets, capturing merchant coupons, punch cards and the like, and authorizing mobile transactions through existing (online) (payment) accounts. The application, that can be downloaded from supported app stores, links the application on a mobile phone directly and securely to user's (online) (payment) accounts through a verification process involving the (online) (payment) accounts. The application provides a single, universal solution for authorizing and initiating transfer of multiple, different value components between the parties involved in a transaction.

An objective of the present invention is to provide an authorization method and system that is easy and simple to use, and completely self-service for the end user in its entire configuration and use.

A further objective of the present invention is to provide an authorization method and system that combines the purchase of goods with additional benefits from loyalty and marketing instruments, e.g. the redemption or issuance of a coupons, rewards, points, punches, etc.

A further objective of the present invention is to provide an authorization method and system that can be used for non-financial authorization requests, e.g. access to a website or physical location, verifying an email address, adding an entry to a white list, signing a mandate, giving consent for an action.

The invention thereto proposes a method for configuring a mobile communication device, comprising the steps of installing and activating (or personalising) an application on the mobile communication device, providing a list of possible service providers by the application, selecting at least one service provider from a list of possible service providers in the application, generating a unique code for the at least one service provider by a platform server, and communicating said unique code to the mobile communication device, entering the unique code on a website of said service provider, sending the entered unique code by the service provider to the platform server for verification and upon verification of the unique code, generating a unique identification code and sending it to the application.

The invention provides several advantages. In general, it provides a generic authorization method using a mobile phone (in particular a smartphone with an internet connection) with an app downloaded from supported app stores. Properties of the invention are further that activation (or personalisation) of the combination of the mobile phone and a mobile number and an app are always initiated from the app, and not, for instance, from the web. The same goes for linking (online) (payment) accounts, and authorizing transaction requests.

A verification of an e-mail address from a set of credentials provided by a user, may—according to the present invention, comprise the steps of:
Downloading an app from an application provider by a user to his phone;
Providing a number of credentials, the credentials comprising an e-mail address by the user in the app;
Sending an e-mail by the application provider to the e-mail address provided by the user;
The e-mail comprising a link to a website;
Upon opening the link, sending a (push) notification to the mobile phone of the user.
Upon confirmation of acceptance of the notification, marking the e-mail address as verified.

Herein, the e-mail further comprises a unique code; and confirmation of acceptance of the notification further requires entering the unique code in the app by the user.

In particular, the unique identification code is a machine-readable code, such as an optical code, i.e. a barcode and/or a QR code, to be displayed by the mobile communication device. A barcode on the mobile device may be preferred when being scanned, as consumers are used to that. For scanning by a user, QR codes may be preferred. In general, any code that can be ‘read’ remotely, that is, optically, or wirelessly or via radio frequency may be applied.

The method may further comprise the steps of entering and verifying a mobile number and email address, in the application at the mobile communication device, and sending this information to the platform server, preferably in an encrypted form.

The method may further comprise the steps of choosing and confirming a PIN code in the application at the mobile communication device, and sending the PIN code to the platform server, preferably in an encrypted form.

The invention further relates to a method for authorizing transactions at the expense of an (online) account, using a mobile communication device, configured according to a method as described above, comprising the steps of communicating, by a mobile communication device to a receiver device, the selected unique identification code on the communication device, and upon receiving the unique identification code, sending an authorization request for the unique identification code by the receiver device to the platform server, receiving by the platform server from a receiver device the unique identification code and a transaction request, forwarding the transaction request to the mobile communication device, returning an authorization of said transaction request to the platform server by the mobile communication device, receiving authorizations from the mobile communication device, initiating the settlement of the transactions at the expense of an (online) account upon confirmation, confirming the transaction to the receiver device and the mobile communication device. A PIN code may be used in addition.

In a further embodiment, communicating a unique identification code, coupled to a mobile communication device by said mobile communication device to a receiver device, comprises communicating the code from the mobile communication device.

In an alternative embodiment, the invention relates to a method for authorizing transactions at the expense of an (online) account, using a mobile communication device, configured as described above, comprising the steps of sending at online checkout an authorization request by the receiver device to the platform server, receiving by the platform server from a receiver device a transaction request, providing a reference code in a mobile communication device readable format to the receiver device, reading, with the mobile communication device the reference code on the receiver device, selecting, at the mobile communication device, the unique identification code to perform the transaction with, sending the reference code and selected unique identification code to the platform server, adding the received unique identification code to the authorization request by the platform server, forwarding the transaction request to the mobile communication device, returning an authorization of said transaction request to the platform server by the mobile communication device, receiving authorizations from the mobile communication device, initiating the settlement of the transactions at the expense of an (online) account upon confirmation, confirming the transaction to the receiver device and/or the mobile communication device. A PIN code may be used in addition.

The method may further comprise the step of confirmation of an authorization request at the mobile communication device by means of a PIN code and/or a biometric code.

The method may even comprise the step of indicating at the mobile communication device which part of the amount of a proposed transaction is to be processed, or the step of authorizing at least part of the amount of a proposed transaction by a coupon, or other value components that may apply to or are included in the transaction.

Furthermore, the invention relates to a mobile communication device, configured as described above, and a system for authorizing transactions at the expense of an (online) account, comprising a mobile communication device configured for receiving a transaction request from a platform server, returning an authorization of said transaction request to the platform server, a platform server connected with a database containing information regarding (online) accounts of a user of said mobile communication device and/or a merchant issuing a transaction requests configured for receiving from a receiver device a unique identification code and a transaction request, forwarding the transaction request to the mobile communication device, receiving authorizations from the mobile communication devices, initiating the settlement of the transactions at the expense of an (online) account upon confirmation, confirming the transaction to the receiver device and the mobile communication device, a receiver device, configured for receiving from a mobile communication device a unique identification code and sending a transaction request to the platform server, and receiving a payment confirmation from the platform server.

In yet another aspect, the invention relates to a method for obtaining, by an Initiating Party (IP), an authorization from an Authorizing Party (AP), to a Service Provider (SP) for performing a transaction on an (online) account of the user, comprising the steps of:
10. Sending a transaction request (A) by the Initiating Party (IP) to a Routing Service (RS) for performing a transaction on the (online) account of an Authorizing Party (AP) at a Service Provider (SP);
   the transaction request (A) comprising an ID of the link to the account (LINK_ID) and properties of the transaction (TRAC_PROP A);
11.Sending a transaction request (B) for the transaction by the Routing Service (RS) to the Service Provider (SP);
   the transaction request (B) comprising the ID of the link to the account (LINK_ID) and properties of the transaction (TRAC_PROP B);
12.Sending an authorization request (C) for the transaction by the Service Provider (SP) to a Validation Service (VS);
   the authorization request (C) comprising the ID of the link to the account (LINK_ID) and properties of the transaction (TRAC_PROP C);
17.Sending an authorization for the execution or cancellation of the transaction by the Authorizing Party (AP) to the Validation Service (VS) to process the transaction;
Entering a PIN CODE by the Authorizing Party (AP);
   the authorization (G) comprising the Transaction ID (TRAC_ID), a execute/cancel indication and a PIN CODE;
18.Responding to the authorization request (C) by the Validation Service (VS) to the Service Provider (SP) after validation of the PIN CODE;
   the response (I) comprising the execute/cancel indication;
19.Executing the transaction by the Service Provider (SP) and generating transaction info;
20.Responding to the transaction request (B) by the Service Provider (SP) to the Routing Service (RS),
   the response (J) comprising the (TRAC_INFO J);
21.Responding to the transaction request (A) by the Routing Service (RS) to the Initiating Party (IP),
   the response (K) comprising (TRAC_INFO K).
22.Sending a confirmation of the transaction (L) by the Routing Service (RS) to the Validation Service (VS),
   the confirmation (L) comprising (TRAC_INFO K);
23.Responding to the authorization (G) by the Validation Service (VS) to the Authorizing Party (AP);
   the response (H) comprising (TRAC_INFO H);
24.Acknowledging the confirmation of the transaction (M) by the Validation Service (VS) to the Routing Service (RS).

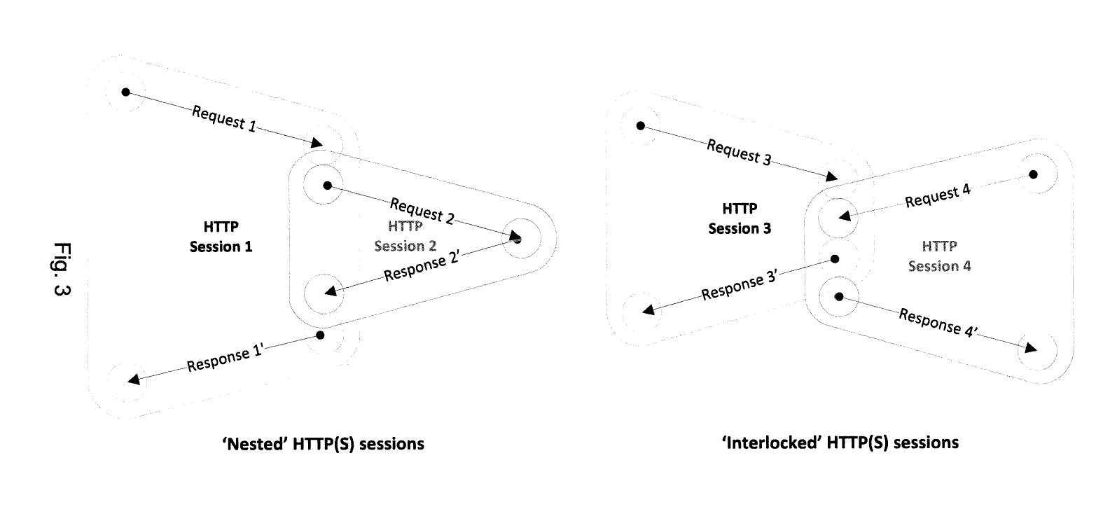

The method is to be seen as a protocol, and preferably, the requests A, B, C and corresponding responses K, J, I are nested HTTP sessions, and the request-response G-H is interlocked with both the request-response C-I and the request-response L-M. FIG. 3 illustrates the nesting method and interlocking method.

In a preferred embodiment, a user of a mobile device, in particular the Authorizing Party (AP), receives a notification of an authorization request. For that purpose, the may comprise the steps of:
13.Assigning a Transaction ID (TRAC_ID) to request (C) by the Validation Service (VS);
14.Sending a notification (D) by the Validation Service (VS) to the authorizing Party (AP);
   the notification (D) comprising the Transaction ID (TRAC_ID);
15.Sending a request for properties of the transaction by the Authorizing Party (AP) to the Validation Service (VS);
   the request (E) comprising the Transaction ID (TRAC_ID);
16.Responding to the request (E) by the Validation Service (VS) to the Authorizing Party (AP);
   the response (F) comprising the properties of the transaction (TRAC_PROP F);

The transaction may be initiated by providing a code, such as a barcode, on a smartphone of the Authorizing Party (AP). In that case, the method may comprise the step of:
9.Receiving a code (N) by the Initiating Party (IP) from the Authorizing Party (AP),
   the code (N) comprising the ID of the link to the account (LINK_ID).

In another embodiment, the step 10 in the method comprises the steps of:
10.1.Sending a request (O) for performing a transaction by a Initiating Party (IP) to the Routing Service (RS);
   the request (O) comprising the transaction properties (TRANS_PROP) and an ID for the Initiating Party (IP).
10.2.Responding to the request (O) by the Routing Services (RS) to the Initiating Party (IP),
   the response (P) comprising a reference code to the registered transaction properties (TRANS_PROP)
10.3.Sending a request (Q) for a virtual representation of the reference code by the Initiating Party (IP) to the Routing Service (RS);
   the request (Q) comprising the reference code
10.4.Responding to the request (Q) by the Routing Service (RS) to the Initiating Party (IP);
   the response (R) comprising the virtual representation of the reference code, e.g. a QR code.
10.5.Presenting the virtual representation (R) by the Initiating Party (IP) to the Authorizing Party (AP);
10.6.Scanning the virtual representation (R) by the Authorizing Party (AP) using the application on the mobile communication device and selecting the Service Provider (SP) to perform the transaction with;
   the virtual representation comprising the reference code
10.7.Sending a request (S) by the Authorizing Party (AP) to the Routing Service (RS) to add the ID of the link to the account (LINK_ID) to the registered transaction properties (TRANS_PROP) and initiating a request B to the Service Provider (SP)
   the request (S) comprising the reference code and ID of the link to the account (LINK_ID).

The numbering of the steps in the above described methods indicates a sequence for performing the steps.

The method may further comprise:
Sending a request (W) by the Validation Service (VS) to an external system for a status of an account;
   the request (W) comprising an account ID;
Receiving a response (X) from the external system;
   the response X comprising an account status.
Sending a request (Y) by the Validation Service (VS) to a external settlement system for executing an authorized transaction;
   the request (Y) comprising the transaction properties;
Receiving a response (Z) from the external settlement system;
   the response (Z) comprising a transaction result.

The invention will now be elucidated into more detail with reference to the following figures. Herein:

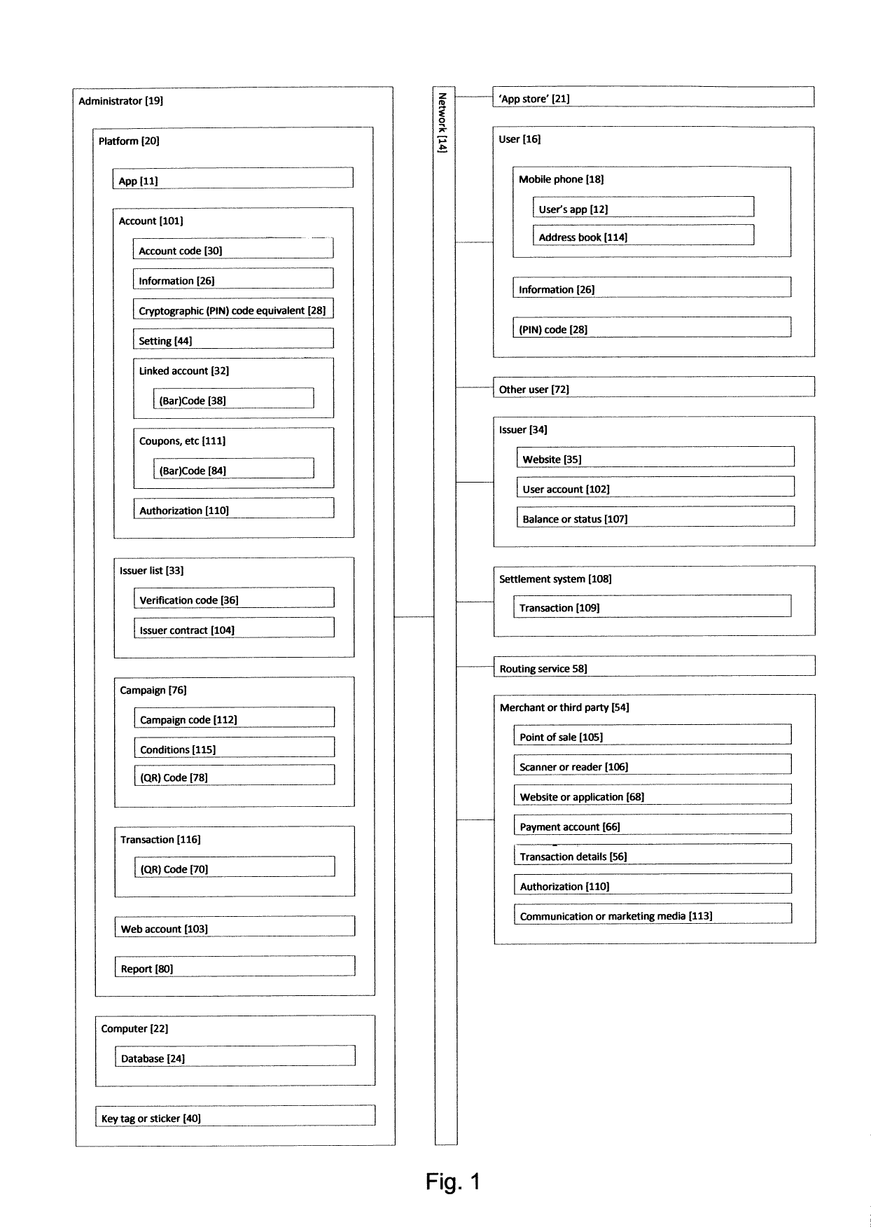

FIG. 1 shows system components of an embodiment of the present invention;

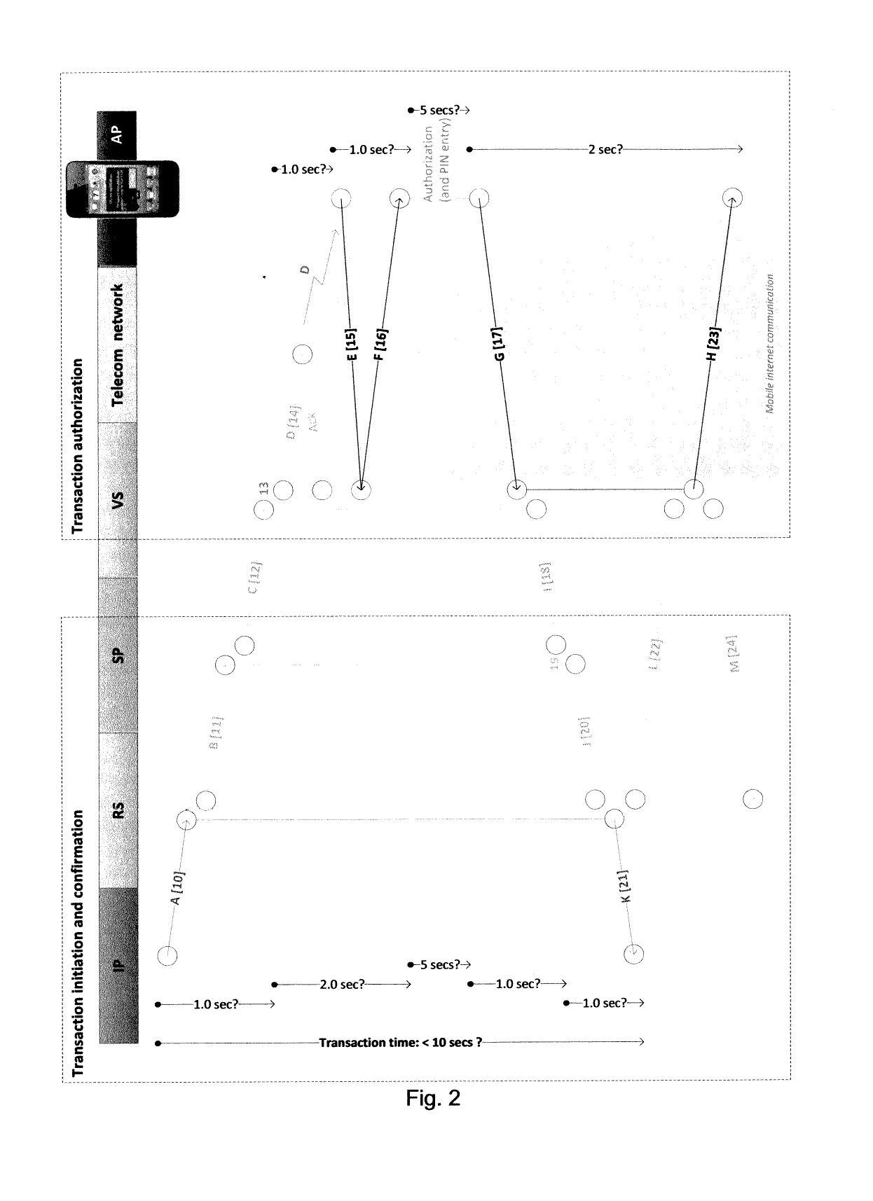

FIG. 2 shows a schematic overview of a method according to the present invention; and

FIG. 3 shows the principle of ‘nested’ and ‘interlocking’ HTTP sessions.

Referring to FIG. 1, the mobile authorization system 10 includes a computer 22 having a database 24 and an application 11 that can be uploaded over an electronic network 14 by an administrator 19 to an app store 21. The application 11 can be downloaded by a user 16 to the user's mobile phone 18 over a network 14.

To use the application 11 the user 16 first downloads the generic application 11 via the electronic network 14 to the mobile phone 18.

On the first opening of the app 11, the app 11 connects to the platform 20 and a key pair is generated and issued for securing all communication. On the platform 20 the app 11 is authenticated and an account 101 is created for use with this instance of the app 12, on this mobile device 18. All communication between app 12 and platform 20 is secured using this key pair. This is also used for encryption of data, e.g. PIN code 28.

Once downloaded, the user 16 activates the user's 16 application 12 on the user's 16 mobile phone 18, from the mobile phone 18, and provides information 26 that includes entry and verification of the mobile phone number, upon which a uniquely associated account 101 is created in the database 24 and an account identification code 30 is provided to the user's 16 phone 18 via the electronic network 14. Creating an account 101 and activating it can in fact only happen from the app 12 on the mobile phone 18.

The user 16 may also provide other personal information 26 such as email address or payment card or loyalty account details depending upon services requested. The information 26 is transmitted via the electronic network 14 to the administrator's 19 platform 20 where the user's 16 information 26 is stored in the database 24. The user 16 also creates a code 28 such as a personal identification number (PIN code) or a biometric element of which a cryptographic equivalent is stored in the database 24. All the information 26 that is received by the administrator's 19 platform 20 from the application 12 from the user's 16 phone 18 through the network 14 is stored in the account 101 in the database 24, preferably in encrypted form.

Once an account 101 with an account code 30 has been uniquely and securely related to the application 12 on the user's 16 mobile phone 18, the user 16 can establish one or more linked accounts 32 through the application 12 on the phone 18. To add a linked account 32 the user 16 selects an issuer 34 from an issuer list 33 of enabled and contracted 104 financial institutions/account issuers 34 maintained by the administrator 19 and transmitted to the application 12 on the user's 16 phone 18. The selected issuer 34 is transmitted to the administrator 19 and a unique verification code 36 is generated by the administrator 19 associated with the user's 16 account 101 and then code 36 is transmitted and shown in the application 12 to the user 16.

The user 16 then accesses the website 35 of the account issuer 34 through the network 14, selects the account 102 to be linked, enters the unique code 36 and confirms the linking action with the means that is custom for authorizing such actions on the account issuer's 34 website 35. The entered code 36 is then transmitted to the administrator's 19 platform 20, and is then validated against the issued code 36 by the administrator 19. When validation occurs a barcode 38 is created by the administrator 19 and provided to the account issuer 34 and to the application 12 on the user's 16 mobile phone 18 via the electronic network 14. The barcode 38 may include a routing identifier. Once linked the account 102 is added to the user's 16 list of linked accounts 32 where the user 16 is able to access the barcode 38, review and modify details of the account 32, and unlink the linked account 32 from account 102. Optionally, a key tag and/or sticker 40 may be provided to the user 16 by the administrator 19.

Only through the application 12 on the user's 16 mobile phone 18, the user 16 has access to the information stored in the account 101 uniquely associated with the application 12 on the user's 16 phone 18. The user can select various options through the settings section 44 of the application 12. For example, the user 16 can add additional functions, such as open a web account 103 on the administrator's platform 20 with web access to the user's 16 account 101. The user 16 can also deactivate the application 12 on the user's 16 phone 18 where the user's 16 encrypted PIN 28, all linked accounts 32 and all information 26 are instantly removed. Some of the information in the removed account 101, e.g. coupons 111 or the like, may be ported to a newly created account 101.

To use the application 12 in an in-store point of sale 105 transaction for purchasing e.g. goods, the user 16 opens the application 12 on the user's 16 phone 18, chooses a linked account 32 and accesses the barcode 38. Alternatively, the user 16 presents their key tag or sticker 40 that have the barcode 38. The merchant 54 scans the barcode 38 with a scanner 106 and then submits the transaction details 56 to a routing service 58. The routing service adds the (payment) account 66 details of the merchant 54 to the transaction details 56, and then routes the barcode 38 and transaction details 56 to the account issuer 34 associated with the barcode 38 The account issuer 34 relates the received barcode 38 to the linked user's account 102, and checks the status, e.g. the balance 107, of the user's account 102. Depending on this check by the issuer 34, a subset of transaction information is transmitted to the user's 16 phone 18 causing a notification to be displayed on the phone 18. If not approved by the issuer 34 the user 16 will be notified to try again or seek authorization through other means. If approved by the issuer 34, the user 16 may close the notification or view a subset of the transaction details 56 for authorization by the user 16. If the user 16 has any applicable coupons 111 or the like they are applied to the same transaction. The user 16 then approves or disapproves of the transaction by selecting the desired response on the phone 18. The user 16 is then prompted to enter their PIN code 28 that is validated against the cryptographic equivalent stored in the database 24. The user may eliminate this step for amounts below a value set in the settings 44.

Once the PIN code 28 is validated, authorization 110 is transmitted from the administrator 19 to the account issuer 34. The account issuer 34 then instantly initiates the required settlement transactions 109 in the appropriate settlement systems 108 (debiting the user 16 on the account 102 and crediting the merchant 54 on the account 66) and immediately passes the approval 110 on to the routing service 58, who forwards it to the merchant 54, who stores the approval 110. The approval 110 is also displayed to the user 16 in the application 12 on the phone 18, and the merchant 34 hands over the goods. The settlement of the transaction 109 through the settlement system 108 is processed asynchronously and may take some time to complete.

Application 12 can also be used for authorizations for online purchases, (payment on) delivery, and bill payments. For such transactions 116 the user 16 accesses the merchant's 54 website 68, fills the online shopping cart, and proceeds to checkout. At checkout, the user 16 selects the present method as the method of payment. Upon selection, rather than have the user 16 input any payment details, the merchant 54 submits the transaction details 56 to the administrator's 19 platform 20 which temporarily stores the received transaction details 56 in a transaction 116 for which it generates a QR code 70 for the user 16 to scan using application 12. The QR code 70 is displayed on the merchant's website 68 for online purchases, on a (e- or paper) bill for bill payment, or on a delivery label for payment upon delivery. The QR code 70 may contain extra visual elements for visual recognition purposes. If the QR code 70 is scanned by a third party app, the QR code will simply redirect to a mobile web page inviting the person to download and activate app 11 and scan again. Once the QR code 70 is scanned with application 12 the user 16 selects a barcode 38 of a linked account 32 for the transaction, and submits this information to the administrator's 19 platform 20. The administrator complements the stored transaction 116 submitted earlier by the merchant 54 with the barcode 38, and from this point forward the process is exactly the same as for an in-store point of sale transaction.

Another option is to use the application 12 for person to person transactions. To use this feature on the application 12 the user 16 selects reverse use in which the application 12 can be used for user 16 to become the beneficiary of transactions with another user 72. To initiate a person to person transaction the user 16 enters the transaction details 56 such as a description of the goods, the amount and scans a user's 72 barcode 38. Other barcodes 38 may be scanned if the user 16 wishes to e.g. split a bill. Once entered, the transaction details 56 including the barcode(s) 38 are submitted to the administrator's 19 platform 20 where the (payment) account 102 details of the user 16 are now added to the transaction details 56. From this point forward the process is exactly the same as for an in-store point of sale transaction, the only difference being that the settlement transaction initiated now debits the user 72 on one account 102 and credits the user 16 on another account 102, and the approval 110 is displayed to both user 72 and user 16 in the applications 12 on their phones 18

The use of the coupon 111 feature of the application 12 is that merchant 54 creates a campaign 76 with special offers and deals under certain conditions 115 at the administrator's 19 website 20, for which a campaign code 112 is generated by the administrator 19. Such campaigns 76 can be used to issue coupons 111, punch cards, vouchers, tickets and the like to users 16. In addition to a campaign, a third party loyalty program can be managed through the application 12 in a similar manner. The merchant 54 then advertises the campaign 76 through conventional communication channels 113 such as print, billboard, online and radio or TV. For each channel a specific QR code 78 is created to be placed on the ad. The user 16 gets a coupon 111 or the like under the campaign 76 by scanning the code 78 into the application 12. If the QR code 78 is scanned by a third party app, the QR code will simply redirect to a mobile web page inviting the person to download and activate app 11 and scan again. Once scanned, the QR code 78 is submitted to the administrator's 19 website 20 and a coupon 111 or the like is displayed in the application 12. When adding the coupon 111 is confirmed by the user 16, a coupon is issued under the campaign 76 and a barcode 84 is generated for the coupon 111 by the administrator's 19 website 20 and the coupon 111 or the like is stored in the user's 16 account 101, complemented with time and location information, if allowed by the user 16 in settings 44. On scan, the user can also choose to share or forward the coupon with other user's 72 from the address book 114 on the user's 16 phone 18. In that case a notification is sent to the other user's 72 phone 16, to notify them of the shared coupon 111 or the like that user 16 has shared with them and invite them to download the app 11. For user 72 the process of adding a coupon 111 or the like to their account 101 is the same as for user 16. For a new user, this means first downloading and activating the app, where the coupon will then be shown. Once linked the coupon 111 or the like is added to the user's 16 list of coupons 111 where the user 16 is able to access the barcode 84, review and modify details of the coupon 111, and delete the coupon 111 or the like through the application 12. Coupons 111 or the like may be automatically deleted based on the campaign's 76 conditions 115.

After issuing of coupons 111 to users 16, the merchant 54 can be provided with communication channel specific reports 80 for campaigns 76. Users 16 may receive notifications in the application 12 with information relating to the coupon 111 or the like, e.g. expiration date and or redemption location, if set by the user in settings 44. A user 16 receives the benefits of the coupon 111 or the like either automatically in a (combined) transaction or by the merchant 54 scanning the barcode 84 of the coupon 111 or the like directly.

Yet another option is to use the application 12 for authorizing non-financial requests sent to the user's 16 phone 18 requested by a third party 54. E.g. a request for access to a third party's website 68 or physical location, verification of user information 26 such as an email address or the like, signing a mandate or standing order on an account 102, entry on a whitelist. To use this feature on the application 12 the user 16 enters their mobile number directly into the website or application 68 of the third party 54, or scans a QR code 70. In both cases the transaction details 56 to initiate are sent to the routing service 58. From this point onward the process is exactly the same as for an in-store point of sale transaction, with the difference that when no account 32 is needed, the issuer 34 is not involved in the process and when an issuer 34 is involved in the process, no settlement transaction 109 needs to be initiated.

FIG. 2 shows a schematic overview of a protocol or method for obtaining, by an Initiating Party (IP), a authorization from an Authorizing party (AP), to a Service Provider (SP) for executing a transaction on an (online) account of the user, comprising the steps of:
10.Sending a transaction request (A) by the Initiating Party (IP) to a Routing Service (RS) for performing a transaction on the (online) account of an Authorizing Party (AP) at a Service Provider (SP);
   the transaction request (A) comprising an ID of the link to the account (LINK_ID) and properties of the transaction (TRAC_PROP A);
11.Sending a transaction request (B) for the transaction by the Routing Service (RS) to the Service Provider (SP);
   the transaction request (B) comprising the ID of the link to the account (LINK_ID) and properties of the transaction (TRAC_PROP B);
12.Sending an authorization request (C) for the transaction by the Service Provider (SP) to a Validation Service (VS);
   the authorization request (C) comprising the ID of the link to the account (LINK_ID) and properties of the transaction (TRAC_PROP C);
13.Assigning a Transaction ID (TRAC_ID) to request (C) by the Validation Service (VS);
14.Sending a notification (D) by the Validation Service (VS) to the authorizing Party (AP);
   the notification (D) comprising the Transaction ID (TRAC_ID);
15.Sending a request for properties of the transaction by the Authorizing Party (AP) to the Validation Service (VS);
   the request (E) comprising the Transaction ID (TRAC_ID);
16.Responding to the request (E) by the Validation Service (VS) to the Authorizing Party (AP);
   the response (F) comprising the properties of the transaction (TRAC_PROP F);
17.Sending an authorization for the execution or cancellation of the transaction by the Authorizing Party (AP) to the Validation Service (VS) to process the transaction;
Entering a PIN CODE by the Authorizing Party (AP);
   the authorization (G) comprising the Transaction ID (TRAC_ID), a execute/cancel indication and a PIN CODE;
18.Responding to the authorization request (C) by the Validation Service (VS) to the Service Provider (SP) after validation of the PIN CODE;
   the response (I) comprising the execute/cancel indication;
19.Executing the transaction by the Service Provider (SP) and generating transaction info;
20.Responding to the transaction request (B) by the Service Provider (SP) to the Routing Service (RS),
   the response (J) comprising the (TRAC_INFO J);
21.Responding to the transaction request (A) by the Routing Service (RS) to the Initiating Party (IP),
   the response (K) comprising (TRAC_INFO K).
22.Sending a confirmation of the transaction (L) by the Routing Service (RS) to the Validation Service (VS),
   the confirmation (L) comprising (TRAC_INFO K);
23.Responding to the authorization (G) by the Validation Service (VS) to the Authorizing Party (AP);
   the response (H) comprising (TRAC_INFO H);
24.Acknowledging the confirmation of the transaction (M) by the Validation Service (VS) to the Routing Service (RS).

In the figure, on the vertical axes, the maximum response times according to the protocol of the present invention for each of the steps are indicated.

FIG. 3 shows the workings of ‘nested’ and ‘interlocking’ HTTP(S) sessions, which are applied in different ways and combination in the protocol or method as shown in FIG. 2.

In nested HTTP sessions, receiving the request of HTTP session A triggers a request of a HTTP session B. Only when a response is received for HTTP session B, is a response created for HTTP session A. This way both sessions are effectively combined into a session across multiple processing nodes.

In interlocking HTTP sessions, after receiving a request of HTTP session C, only a request of HTTP session D triggers the response for HTTP session C, which in turn only triggers the response for HTTP session D.

1. Method for configuring a mobile communication device, comprising the steps of:
installing an application from an app store on the mobile communication device;
activating or personalising the application on the mobile communication device;
providing a list of possible service providers by the application;
selecting a service provider from a list of possible service providers in the application;
generating a unique code for a selected service provider by a platform server, and communicating said unique code to the mobile communication device;
entering the unique code on a website of said service provider;
sending the entered unique code by the service provider to the platform server for verification;
upon verification of the unique code, generating a unique identification code and sending it to the service provider, and to the application.

2. Method according to claim 1, wherein the unique identification code is a machine readable code, optically through i.e. a barcode and/or a QR code, or wirelessly through a radio frequency or wireless transmission, to be issued by the mobile communication device.

3. Method according to claim 1 or 2, comprising the steps of:
choosing a pin code or a biometric element in the application at the mobile communication device;
sending the pin code to the platform server.

4. Method for authorizing transactions at the expense of an account, using a mobile communication device, configured according to a method of any of claims 1-3, comprising the steps of:
communicating, by the mobile communication device to a receiver device, the unique identification code of a selected account;
upon receiving the unique identification code it is added to the transaction details;
sending a transaction request with the unique code of the receiver device to the platform server;
receiving by the platform server from a receiver device an account identification code and a transaction request;
sending an authorization request for the transaction request to the mobile communication device;
receiving an authorization of said transaction request by the platform server from the mobile communication device;
validating the authorization by the platform server;
performing the transactions at the expense of an online account upon confirmation and initiating settlement in a settlement network or system;
confirming the payment to the receiver device and/or the mobile communication device.

5. Method according to claim 1, wherein communicating a unique identification code, coupled to a mobile communication device by said mobile communication device to a receiver device, comprises optically displaying the code on the mobile communication device.

6. Method for authorizing online transactions at the expense of an account, using a mobile communication device, configured according to a method of any of claims 1-3, comprising the steps of:
selecting, by a user, at a checkout, an option to make a payment by means of a the present mobile authorization method;
submitting by a merchant a transaction request to a platform server;
providing, by the platform server, a reference to the transaction request in a mobile communication device readable format to be presented by the merchant to the user;
scanning, by the user, the reference to a transaction request with the mobile communication device;
selecting, at the mobile communication device, a service provider to perform the transaction with and submitting the transaction for processing;
sending an authorization request for the transaction request to the mobile communication device;
receiving an authorization of said transaction request by the platform server from the mobile communication device;
validating the authorization by the platform server;
performing the transactions at the expense of an online account upon confirmation and initiating settlement in a settlement network or system;
confirming the payment to the receiver device and/or the mobile communication device.

7. Method according to any of claim 4, 5 or 6, comprising the step of confirmation of an authorization request at the mobile communication device by means of a pin code or a biometric code.

8. Method according to any of claims 4-7, comprising the step of indicating at the mobile communication device which part of the amount of a proposed transaction is to be processed.

9. Method according to any of claims 4-8, comprising the step of paying at least part of the amount of a proposed payment by a coupon.

10. Mobile communication device, configured according to any of claims 1-3.

11. System for authorizing transactions at the expense of an account, comprising:
a mobile communication device,
having a unique identification code, and
configured for:
at least upon request communicating said identification code to a receiver device;
receiving a transaction request from a platform server;
returning an authorization of said transaction request to the platform server;
a platform server
connected with a database containing information regarding an online account of a user of said mobile communication device and/or a merchant issuing a transaction request;
configured for:
receiving from a receiver device an identification code of a mobile communication device and a transaction request;
forwarding the transaction request to the mobile communication device;
receiving authorizations from the mobile communication devices;
performing the transactions at the expense of an online account upon confirmation;
confirming the payment to the receiver device and/or the mobile communication device;
a receiver device, configured for:
receiving a unique identification code from a mobile communication device;
sending a transaction request for an received unique identification code to the platform server;
receiving a transaction confirmation from the platform server.

12. Method for obtaining, by an Initiating Party (IP), an authorization from an Authorizing Party (AP), to a Service Provider (SP) for performing a transaction on an account of the user, comprising the steps of:
10.Sending a transaction request (A) by the Initiating Party (IP) to a Routing Service (RS) for performing a transaction on the (online) account of an Authorizing Party (AP) at a Service Provider (SP);
the transaction request (A) comprising an ID of the link to the account (LINK_ID) and properties of the transaction (TRAC_PROP A);
11.Sending a transaction request (B) for the transaction by the Routing Service (RS) to the Service Provider (SP);
the transaction request (B) comprising the ID of the link to the account (LINK_ID) and properties of the transaction (TRAC_PROP B);
12.Sending an authorization request (C) for the transaction by the Service Provider (SP) to a Validation Service (VS);
the authorization request (C) comprising the ID of the link to the account (LINK_ID) and properties of the transaction (TRAC_PROP C);
17.Sending an authorization for the execution or cancellation of the transaction by the Authorizing Party (AP) to the Validation Service (VS) to process the transaction;
Entering a PIN CODE by the Authorizing Party (AP);
the authorization (G) comprising the Transaction ID (TRAC_ID), a execute/cancel indication and a PIN CODE;
18.Responding to the authorization request (C) by the Validation Service (VS) to the Service Provider (SP) after validation of the PIN CODE;
the response (I) comprising the execute/cancel indication;
19.Executing the transaction by the Service Provider (SP) and generating transaction info;
20.Responding to the transaction request (B) by the Service Provider (SP) to the Routing Service (RS),
the response (J) comprising the (TRAC_INFO J);
21.Responding to the transaction request (A) by the Routing Service (RS) to the Initiating Party (IP),
the response (K) comprising (TRAC_INFO K).
22.Sending a confirmation of the transaction (L) by the Routing Service (RS) to the Validation Service (VS),
the confirmation (L) comprising (TRAC_INFO K);
23.Responding to the authorization (G) by the Validation Service (VS) to the Authorizing Party (AP);
the response (H) comprising (TRAC_INFO H);
24.Acknowledging the confirmation of the transaction (M) by the Validation Service (VS) to the Routing Service (RS).

13. Method according to claim 12, wherein the requests A, B, C and corresponding responses K, J, I are nested HTTP sessions, and the request-response G-H is interlocked with both the request-response C-I and the request-response L-M.

14. Method according to claim 13, comprising the steps of:
13.Assigning a Transaction ID (TRAC_ID) to request (C) by the Validation Service (VS);
14.Sending a notification (D) by the Validation Service (VS) to the authorizing Party (AP);
the notification (D) comprising the Transaction ID (TRAC_ID);
15.Sending a request for properties of the transaction by the Authorizing Party (AP) to the Validation Service (VS);
the request (E) comprising the Transaction ID (TRAC_ID);
16.Responding to the request (E) by the Validation Service (VS) to the authorizing party (AP);
the response (F) comprising the properties of the transaction (TRAC_PROP F);

15. Method according to any of claims 12-14, comprising the steps of:
9.Receiving a code (N) by the Initiating Party (IP) from the Authorizing Party (AP),
the code (N) comprising the ID of the link to the account (LINK_ID).

16. Method according to any of claims 12-14, comprising the steps of:
10.1.Sending a request (O) for performing a transaction by a Initiating Party (IP) to the Routing Service (RS);
the request (O) comprising the transaction properties (TRANS_PROP) and an ID for the Initiating Party (IP).
10.2.Responding to the request (O) by the Routing Services (RS) to the Initiating Party (IP),
the response (P) comprising a reference code to the registered transaction properties (TRANS_PROP)
10.3.Sending a request (Q) for a virtual representation of the reference code by the Initiating Party (IP) to the Routing Service (RS);
the request (Q) comprising the reference code
10.4.Responding to the request (Q) by the Routing Service (RS) to the Initiating Party (IP);
the response (R) comprising the virtual representation of the reference code, e.g. a QR code.
10.5.Presenting the virtual representation (R) by the Initiating Party (IP) to the Authorizing Party (AP);
10.6.Scanning the virtual representation (R) by the Authorizing Party (AP) using the application on the mobile communication device and selecting the Service Provider (SP) to perform the transaction with;
virtual representation comprising the reference code
10.7.Sending a request (S) by the Authorizing Party (AP) to the Routing Service (RS) to add the ID of the link to the account (LINK_ID) to the registered transaction properties (TRANS_PROP) and initiating a request B to the Service Provider (SP)
the request (S) comprising the reference code and ID of the link to the account (LINK_ID).

17. Method according to any of claims 12-16, further comprising:
Sending a request (W) by the Validation Service (VS) to an external system for a status of an account;
request (W) comprising an account ID;
Receiving a response (X) from the external system;
response X comprising an account status.
Sending a request (Y) by the Validation Service (VS) to a external settlement system for executing an authorized transaction;
request (Y) comprising the transaction properties;
Receiving a response (Z) from the external settlement system;
response (Z) comprising a transaction result.

18. Method for verifying an e-mail address from a set of credentials provided by a user, comprising:
Downloading an app from an application provider by a user to his phone;
Providing a number of credentials, the credentials comprising an e-mail address by the user in the app;
Sending an e-mail by the application provider to the e-mail address provided by the user;
The e-mail comprising a link to a website;
Upon opening the link, sending a (push) notification to the mobile phone of the user.
Upon confirmation of acceptance of the notification, marking the e-mail address as verified.

19. Method according to claim 18, wherein:
The e-mail further comprises a unique code; and
Confirmation of acceptance of the notification further requires entering the unique code in the app by the user.
